(19) United States
(12) Patent Application Publication
(10) Pub. No.: US 2023/0373841 A1
(43) Pub. Date: Nov. 23, 2023

(54) MOLDING MOLD OF GLASS PRODUCT

(71) Applicant: AAC Optics (Chongqing) Co., Ltd., Chongqing (CN)

(72) Inventors: Zhengmin Banjamin Pan, L.A., CA (US); Linzhi Zhao, Chongqing (CN)

(21) Appl. No.: 18/365,168

(22) Filed: Aug. 3, 2023

Related U.S. Application Data
(63) Continuation of application No. PCT/CN2022/108447, filed on Jul. 28, 2022.

(30) Foreign Application Priority Data
Apr. 25, 2022 (CN) 202220984233.X

(51) Int. Cl. C03B 11/08

(52) U.S. Cl. CPC C03B 11/08; C03B 2215/50; C03B 2215/46

(57) ABSTRACT

A molding mold of a glass product includes a lower mold defining a first molding surface and an upper mold defining a second molding surface. The first molding surface is disposed on one side of the lower mold close to the upper mold. The second molding surface is opposite to the first molding surface. The first molding surface includes a first molding portion and a first fixing portion disposed on a periphery of the first molding portion. The second molding surface includes a second molding portion and a second fixing portion disposed on a periphery of the second molding portion. The lower mold includes a support portion extending from the first fixing portion of the lower mold toward the second fixing portion. The support portion abuts against the second fixing portion, so that the first molding portion and the second molding portion form a molding chamber.

### TECHNICAL FIELD

The present disclosure relates to a field of optics, and in particular to a molding mold of a glass product.

### BACKGROUND

Lenses are optical components made of transparent substance (such as glass, plastic, etc.), which are widely used in various fields such as security, car, digital camera, laser, optical instruments, etc. With continuous development of the market, an application of the lenses is more and more widespread. Especially with development of the Internet era, electronic devices, such as cell phones, tablets, notebooks, etc., are more and more common. Therefore, the requirements for the lenses applied to the electronic devices are also getting higher and higher.

In the prior art, wafer-level lenses made of glass are generally produced by thermoforming using a glass processing mold. After the glass processing mold is closed, a mold body encloses a gap with a predetermined shape, which is configured to limit a shape of a glass substrate in a heated state. Then the glass substrate is cooled to form a glass product with the predetermined shape.

### SUMMARY

A purpose of the present disclosure is to provide a molding mold of a glass product having long service life.

To achieve the above purpose, the present disclosure provides the molding mold of the glass product. The molding mold of the glass product comprises a lower mold defining a first molding surface and an upper mold defining a second molding surface.

The first molding surface is disposed on one side of the lower mold close to the upper mold. The second molding surface is disposed on one side of the upper mold close to the lower mold. The first molding surface comprises a first molding portion configured to mold the glass product and a first fixing portion disposed on a periphery of the first molding portion. The second molding surface comprises a second molding portion corresponding to the first molding portion and a second fixing portion disposed on a periphery of the second molding portion.

The molding mold further comprises at least one support portion extending from the first fixing portion of the lower mold toward the second fixing portion. The at least one support portion abuts against the second fixing portion, so that the first molding portion and the second molding portion form a molding chamber.

Optionally, one support portion is provided and the support portion is a hollow circular ring structure.

Optionally, a plurality of support portions are provided. The plurality of support portions are disposed at intervals. The plurality of support portions are spaced apart from each other.

Optionally, the at least one support portion and the lower mold are integrally formed.

Optionally, the lower mold is a fixed mold, and the upper mold is a movable mold.

Optionally, a groove matched with the at least one support portion is defined on the upper mold. When the upper mold is connected to the lower mold, the at least one support portion is embedded in the groove for positioning.

Optionally, the at least one support portion is disposed at an outer peripheral edge of the first fixing portion.

Compared with the prior art, a lens made by the molding mold of the present disclosure is directly molded, thereby improving molding efficiency of the lens.

In one embodiment, the lower mold of the molding mold comprises the support portion. The support portion is an integrally formed ring-shaped support portion, which improves a molding precision.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor. In the drawing:

FIG. 1 is an exploded schematic diagram of a molding mold according to one embodiment of the present disclosure.

FIG. 2 is a schematic diagram of a lower mold of the molding mold according to one embodiment of the present disclosure.

FIG. 3 is a schematic diagram of an upper mold of the molding mold according to one embodiment of the present disclosure.

FIG. 4 is a cross-sectional schematic diagram of the molding mold according to one embodiment of the present disclosure.

FIG. 5 is a schematic diagram of the upper mold of the molding mold according to another embodiment of the present disclosure.

FIG. 6 is a cross-sectional schematic diagram of the molding mold according to another embodiment of the present disclosure.

### DETAILED DESCRIPTION

Technical solutions in the embodiments of the present disclosure will be clearly and completely described below in conjunction with the accompanying drawings in the embodiments of the present disclosure. Obviously, the described embodiments are only a part of the embodiments of the present disclosure, rather than all of the embodiments. Based on the embodiments of the present disclosure, all other embodiments obtained by those of ordinary skill in the art without creative work shall fall within the protection scope of the present disclosure.

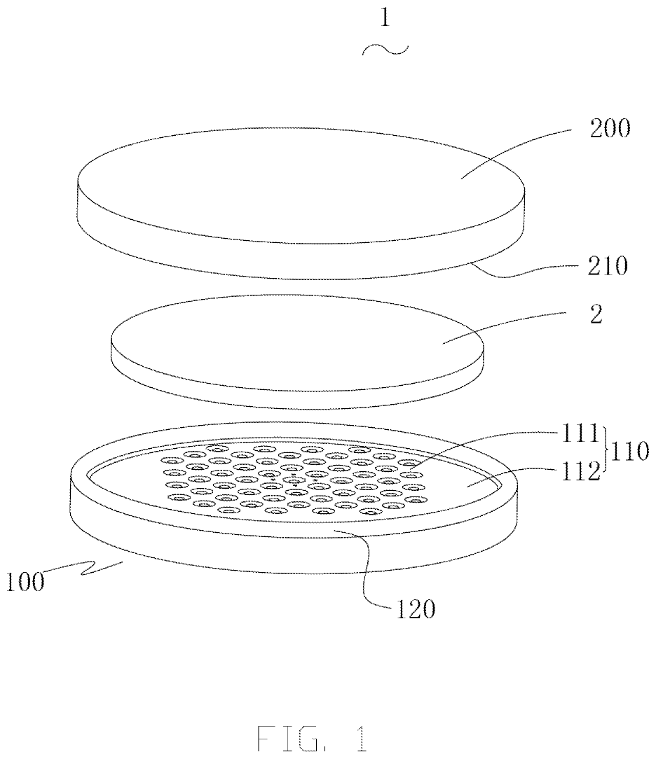

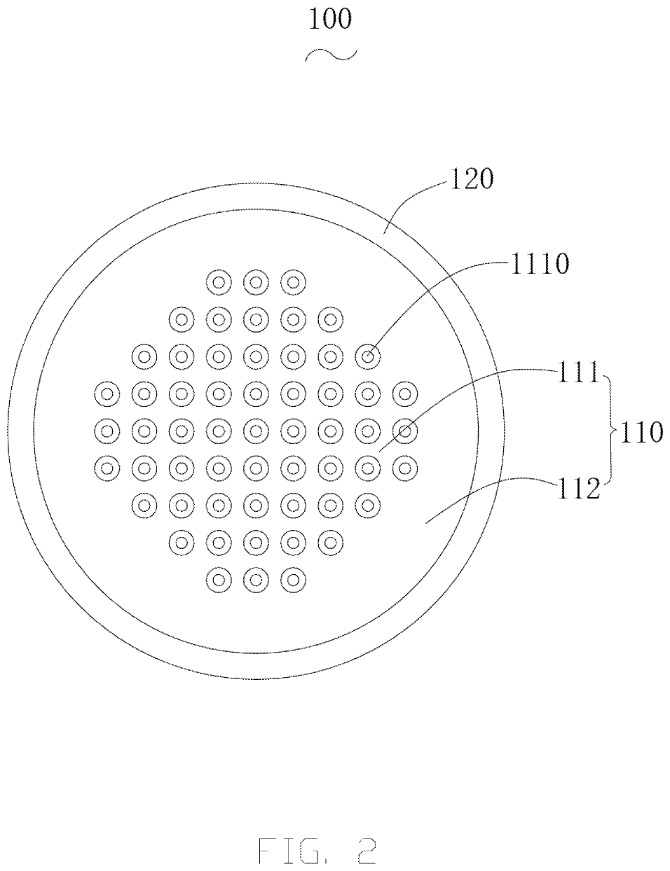

As shown in FIGS. 1-6, the present disclosure provides a molding mold 1 of a glass product. The molding mold 1 of the glass product comprises a lower mold 100 defining a first molding surface 110 and an upper mold 200 defining a second molding surface 210.

The first molding surface 110 is disposed on one side of the lower mold 100 close to the upper mold 200. The second molding surface 210 is disposed on one side of the upper mold 200 close to the lower mold 100. The first molding surface 110 comprises a first molding portion 110 configured to mold the glass product and a first fixing portion 112 disposed on a periphery of the first molding portion 111. The second molding surface 210 comprises a second molding portion 211 corresponding to the first molding portion 111 and a second fixing portion 212 disposed on a periphery of the second molding portion 211.

The lower mold 100 further comprises at least one support portion 120 extending from the first fixing portion 112 of the lower mold 100 toward the second fixing portion 212. When the upper mold 200 is connected to the lower mold 100, the at least one support portion 120 abuts against the second fixing portion 212, so that the first molding portion 111 and the second molding portion 211 form a molding chamber 10.

In the embodiment, the first molding portion 111 comprises a plurality of first molding cavities 1110. A plurality of second molding cavities 2110 corresponding to the plurality of first molding cavities 1110 are defined on the second molding portion 211. Spaced space between the plurality of first molding cavities 1110 and the plurality of second molding cavities 2110 forms a molding space of a lens. A glass substrate 2 is pressed and molded into a basic shape structure of the lens in the molding space.

In the embodiment, the plurality of first molding cavities 1110 may be bulges or recesses, and the plurality of second molding cavities 2110 may also be the bulges or the recesses. That is, shapes of the first molding portion 111 and the second molding portion 211 are determined according to a specific structure of the lens, depending on a diameter of the lens, a thickness of the lens, a curved surface shape of an incident surface of the lens, and a curved surface shape of an emergent surface of the lens.

The glass substrate 2 is molded into the glass product in the molding mold 1 of the glass product. When the glass substrate 2 forms a geometric shape of the lens and a temperature drops below a glass transition temperature value, the lower mold 100 and the upper mold 200 are separated by an execution mechanism, so as to obtain the glass product.

In one alternative embodiment, glass fluid may be directly poured into the molding chamber 10, and the glass fluid is pressed and cooled in the molding space to form the glass product.

In the alternative embodiment, one support portion 120 is provided and the support portion 120 is the hollow circular ring structure. The support portion and the first molding surface 110 are enclosed to form a circular space. The circular space and the second molding surface 210 are enclosed to forms the molding chamber 10 of the glass substrate 2. By connecting the lower mold and the upper mold, the glass substrate 2 is pressed and molded in the molding chamber 10. Of course, in other possible embodiments, the support portion 120 may also be an elliptical ring structure, a square-shaped ring structure, or other ring structure.

In one alternative embodiment, a plurality of support portions 120 are provided. The plurality of support portions 120 are disposed at intervals. The plurality of support portions 120 are spaced apart from each other. The plurality of support portions 120 form a ring-like structure.

In one optional embodiment, the support portion 120 is disposed at an outer peripheral edge of the first fixing portion 112 to minimize an overall size of the molding mold 1.

In the embodiment, the at least one support portion 120 and the lower mold 100 are integrally formed. The support portion 120 is integrally formed with the lower mold 100, which ensures a shape precision of the molding chamber after the upper mold is connected to the lower mold. Of course, in other embodiments, the support portion 120 may be separated from the lower mold 100. However, the support portion 120 that is integrally formed has an advantage of higher precision compared to the support portion 120 having a separate structure.

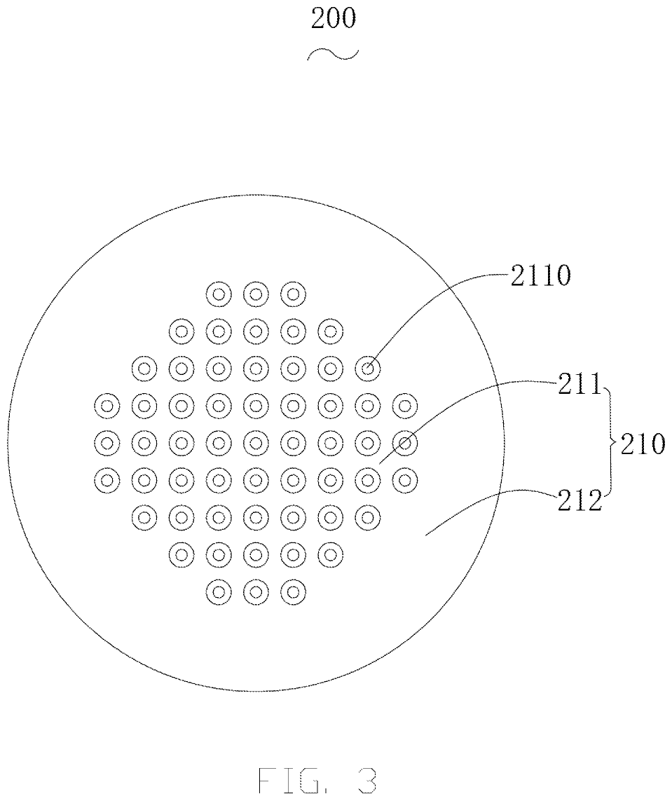

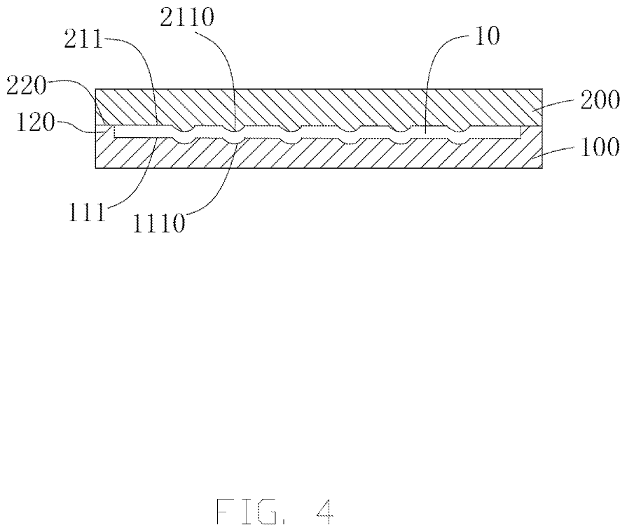

In the embodiment, as shown in FIGS. 3-4, the second fixing portion 212 of the upper mold 200 is a planar structure extending to an edge of the upper mold 200, so that the upper mold 200 and the lower mold 100 do not need to be additionally positioned with the support portion 120 when the upper mold 200 and the lower mold are connected.

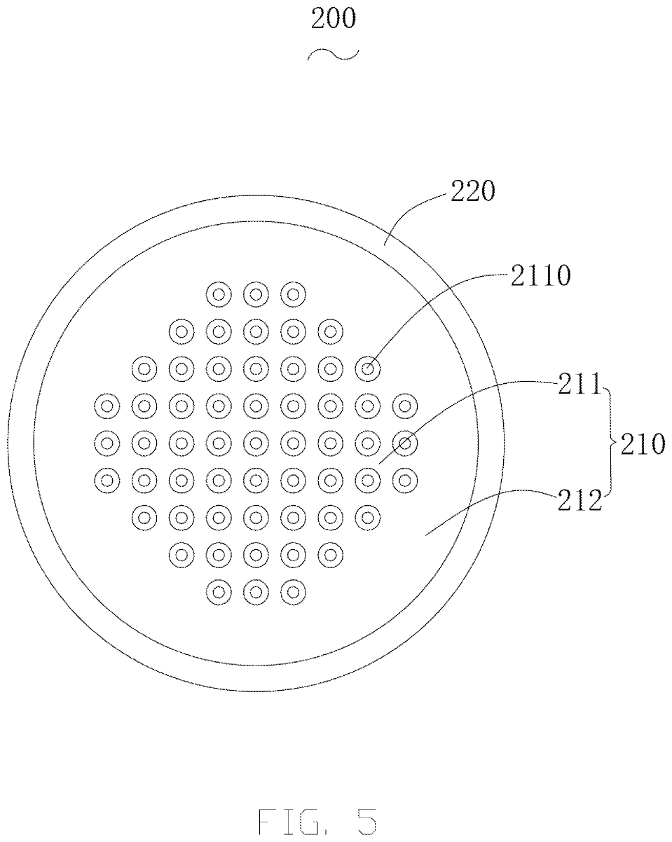

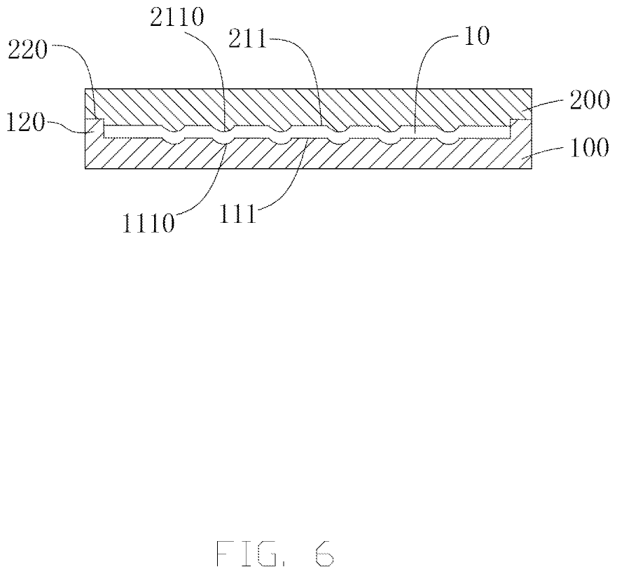

As shown in FIGS. 5-6, in another embodiment, a groove 220 matched with the support portion 120 is defined on the second fixing portion 212 of the upper mold 200. The support portion 120 is embedded in the groove 220 for positioning after the upper mold is connected to the lower mold. By an arrangement of the groove 220, after the molding mold is closed, a positioning precision of the molding chamber 10 is further improved.

In the embodiment, the lower mold 100 is a fixed mold, and the upper mold 200 is a movable mold. The upper mold 200 is controlled by the execution mechanism to perform actions such as opening the molding mold and closing the molding mold.

In the embodiment, the upper mold 200 and the lower mold 100 of the molding mold 1 may be processed and manufactured by materials such as tungsten steel or stainless steel, and may be manufactured by metal cutting. The formed molding mold also needs to perform a subsequent process such as metal coating, thereby ensuring the precision of the glass product while ensuring service life of the molding mold.

Compared with the prior art, the glass product is directly molded by the molding mold of the present disclosure, thereby improving molding efficiency of the glass product.

In one embodiment, the lower mold of the molding mold comprises the support portion. The support portion is integrally formed, which improves the molding precision.

The above are only the embodiments of the present disclosure. It should be pointed out that for those of ordinary skill in the art, improvements can be made without departing from the inventive concept of the present disclosure, and these improvements fall within the protection scope of the present disclosure.

What is claimed is:

1. A molding mold of a glass product, comprising:
a lower mold defining a first molding surface, and
an upper mold defining a second molding surface;
wherein the first molding surface is disposed on one side of the lower mold close to the upper mold; the second molding surface is disposed on one side of the upper mold close to the lower mold; the first molding surface comprises a first molding portion configured to mold the glass product and a first fixing portion disposed on a periphery of the first molding portion; the second molding surface comprises a second molding portion corresponding to the first molding portion and a second fixing portion disposed on a periphery of the second molding portion;
wherein the molding mold further comprises at least one support portion extending from the first fixing portion of the lower mold toward the second fixing portion; the at least one support portion abuts against the second fixing portion, so that the first molding portion and the second molding portion form a molding chamber.

2. The molding mold of the glass product according to claim 1, wherein one support portion is provided and the support portion is a hollow circular ring structure.

3. The molding mold of the glass product according to claim 1, wherein a plurality of support portions are provided; the plurality of support portions are disposed at intervals; the plurality of support portions are spaced apart from each other.

4. The molding mold of the glass product according to claim 1, wherein the at least one support portion and the lower mold are integrally formed.

5. The molding mold of the glass product according to claim 1, wherein the lower mold is a fixed mold, and the upper mold is a movable mold.

6. The molding mold of the glass product according to claim 1, wherein a groove matched with the at least one support portion is defined on the upper mold; when the upper mold is connected to the lower mold, the at least one support portion is embedded in the groove for positioning.

7. The molding mold of the glass product according to claim 1, wherein the at least one support portion is disposed at an outer peripheral edge of the first fixing portion.
